(19) United States
(12) Patent Application Publication
(10) Pub. No.: US 2018/0017024 A1
(43) Pub. Date: Jan. 18, 2018

(54) HEAT EXCHANGER FOR AN EGR SYSTEM

(71) Applicant: Borgwarner Emissions Systems Spain, S.L.U., Vigo (ES)

(72) Inventors: Xoan Xosé Hermida Domínguez, Gondomar (ES); Rafael Juliana, Vigo (ES); Alejandro Vargas, Vigo (ES); Rodolfo Prieto Domínguez, Nigrán (ES); Ana Otero Vázquez, Chantada-Lugo (ES)

(73) Assignee: Borgwarner Emissions Systems Spain, S.L.U., Vigo (ES)

(21) Appl. No.: 15/646,308

(22) Filed: Jul. 11, 2017

(30) Foreign Application Priority Data
Jul. 12, 2016 (EP) 16382330.5

(51) Int. Cl. F28F 9/00; F28F 3/04; F28F 3/08

(52) U.S. Cl. CPC F02M 26/28; F28F 9/001; F28F 3/08; F02M 26/32; F28F 3/044; F28F 3/046

(57) ABSTRACT

The invention relates to a heat exchanger for an EGR (Exhaust Gas Recirculation) system, comprising a tube bundle of flat tubes, configured by combining two plates incorporating specific protrusions distributed according to the direction of the tube. These protrusions in both plates are in contact with one another or attached such that they establish internal channels. The present invention is characterized by the presence of either transverse projections or of transverse deviations generating disturbances in the flow through side walls of the internal channels, increasing the turbulence of the flow through said channels and thereby increasing heat exchange by convection.

### CROSS-REFERENCE TO RELATED APPLICATIONS

The present application claims priority from EP Application No. 16382330.5 filed Jul. 12, 2016, the disclosure of which is hereby incorporated herein by reference.

### OBJECT OF THE INVENTION

The present invention is a heat exchanger for an EGR (Exhaust Gas Recirculation) system comprising a tube bundle of flat tubes, configured by combining two plates incorporating specific protrusions distributed according to the direction of the tube. These protrusions in both plates are in contact or attached such that they establish internal channels.

The present invention is characterized by the presence of either transverse projections or of transverse deviations generating disturbances in the flow through side walls of the internal channels, increasing the turbulence of the flow through said channels and thereby increasing heat exchange by convection.

The present invention is of interest due to its integration in EGR systems, and therefore for its contribution to reducing the environmental impact of internal combustion engines.

### BACKGROUND OF THE INVENTION

One of the fields of the art that has been most intensely developed is that of EGR systems due to the increasingly more demanding regulations in relation to reducing emissions for vehicles with an internal combustion engine.

The space of the engine compartment must house an increasingly larger number of devices, which requires that these devices are as compact as possible. Among devices incorporating an EGR system there is included a heat exchanger responsible for cooling the exhaust gas recirculated to the engine intake to reduce the oxygen content.

For a recirculated gas flow rate and a specific rise in temperature, the only way to reduce the volume of the heat exchanger is to increase the exchange surface or to improve the convection heat transfer coefficient.

The most widely used heat exchangers incorporate a tube bundle through which the gas to be cooled circulates. This tube bundle is immersed in a liquid coolant that removes the heat given off by the gas.

An important progress in the design of compact exchangers was to introduce flat tubes to form the tube bundle. The flat tubes have a rectangular section where the larger faces can incorporate protrusions increasing the turbulence of the gas circulating therethrough. A large number of patent applications intended for configuring specific patterns of protrusions improving the heat transfer coefficient are known.

This configuration of flat tubes has turned out to be very efficient since the pressure drops in the gas flowing through the tube are less than the drops in the tubes that have a circular section.

The patterns of protrusions are incorporated in the two larger faces of the flat tube such that the protrusions of one larger face and the protrusions of the other larger face partially penetrate the section of the tube mainly by disturbing the flow located close to said faces.

Between the crests of the protrusions of both faces there is a section that still allows the passage of the flow; nevertheless, given that the protrusions of one face do not have to coincide with the protrusions of the other face, the effective passage section is greater than the apparent section observed in a cross-section view of the tube.

Nevertheless, the depth of the tubes has a limit since further reducing the section of the tube would lead to pressure drops that would worsen the overall efficiency of the flat tube.

In these flat tubes, the side walls are flat due to the particular way of manufacturing the flat tubes.

The method of manufacturing flat tubes makes use of a single flat metal strip that is stamped in the regions corresponding to the larger faces, and it is subsequently bent along the length thereof continuously until forming the flat tube.

The strip is drawn through rollers primarily supported on the regions corresponding to at least one of the smaller faces of the tube; therefore this region must be flat. The free edges of the strip come into contact after the folding operations and are welded with a continuous weld bead. This smaller face also has to be flat.

Both the support of the rollers and the welding operation are conditioning factors that mean that the protrusions are located only in the larger faces of the tubes and that the side walls and the smaller sides of the flat tube are flat.

In practice there is an additional limitation. The protrusions of the larger faces must have a minimum distance from the walls since the bending operation for bending the vertices leading to the walls require this distance for being able to perform a correct bending operation.

This minimum distance and the fact that the walls are flat lead to passage channels in which the protrusions of the larger faces do not impose a turbulent regime, and therefore they are regions in which the heat transfer coefficient is lower.

The present invention solves these problems by means of a flat tube that allows generating side walls either with projections or with deviations, increasing the disturbances imposed on the gas flow to increase the convection heat transfer coefficient without deteriorating the pressure drop.

### DESCRIPTION OF THE INVENTION

The present invention is a heat exchanger for an EGR system intended for establishing the heat exchange between a first fluid, the exhaust gas of an internal combustion engine, and a second fluid, a liquid coolant with a very compact configuration due to the high coefficient of heat transfer in the heat exchange tubes it incorporates.

The heat exchanger according to a first aspect of the invention comprises:
a shell with an inlet and an outlet of the second fluid;
a heat exchange tube bundle housed inside the shell formed by stacking flat tubes having a rectangular section arranged parallel to one another, extending according to a longitudinal direction between an inlet of the first fluid and an outlet of the first fluid;
wherein the space between the exchange tube bundle and the shell is configured for the passage of the second fluid; and
wherein the flat tubes of the tube bundle comprise an expansion in the direction of the stack of the tube bundle at the ends thereof to establish a passage space between tubes for the second fluid.

Use will be made of three main directions perpendicular to one another throughout the description. The three main directions take the tubes of the tube bundle as reference elements. The main directions are then defined.

The longitudinal direction identified as X-X′ is the direction established by the longitudinal direction along which the heat exchange tube bundle extends.

The tubes have a flat configuration because they extend according to a main plane. The main plane contains two main directions perpendicular to one another, one being the longitudinal direction X-X′ and the other the transverse direction identified as Y-Y′. The flat tubes have a rectangular section. Given that the cross-section is perpendicular to the longitudinal direction X-X′, this rectangular section has a larger side which is the one extending along the transverse direction Y-Y′.

The same rectangular section of the flat tube has a smaller side according to the perpendicular direction with respect to the transverse direction Y-Y′. This perpendicular direction will be identified as Z and is the direction in which the stack of tubes forming the tube bundle is established.

As indicated, the tubes have a rectangular section and are arranged parallel to one another. At the ends the tubes have an expansion in direction Z of the stack such that said ends also result in a rectangular section. The stack of the tube bundle is supported on these ends. Since the expansion is located at the ends, in the rest of the length of the tubes of the tube bundle there is a separation between tubes that allows the passage of the second fluid, removing the heat from the larger surfaces of the flat tubes.

The tube bundle does not require a die-cut baffle in which the ends of the tubes are attached. The tube bundle is stacked, with the expansions of the ends in contact and welded together, such that according to a cross-section, the only restriction to the passage of the first fluid into the inlet is the edge of the tubes.

The tube bundle thus configured is housed in a shell that has an inlet and an outlet of the second fluid where this second fluid flows between the spaces existing between tubes and in the space between tubes and shell.

In a particular embodiment, the shell housing the tube bundle has a rectangular section.

In another particular embodiment, said shell having a rectangular section has the inlet and the outlet of the second fluid in a face such that the inlet and the outlet of said second fluid is parallel to the main plane of the tubes of the tube bundle.

The increase in heat transfer in this heat exchanger is due to the fact that at least one of the tubes of the tube bundle:
is configured by attaching two flat plates with bent sides, such that an inner face of the bent side of a plate is attached to the outer face of the bent side of the other plate;
wherein both plates have groups of first protrusions distributed along the longitudinal direction, wherein at least one plate has one or more second protrusions deeper than the first protrusions that reach the opposite plate, both plates being either in contact with one another or being attached by means of the at least one second protrusion, forming longitudinal channels inside the flat tube,
and wherein, given the transverse direction as the perpendicular direction with respect to the longitudinal direction contained in the main plane of the flat tube, the second protrusion or protrusions have either projections in the transverse direction or deviations in the transverse direction, or both, for disturbing the flow of the first fluid in the transverse direction from the walls of the channel formed by said second protrusions.

The tubes are configured by means of attaching two plates by bending the sides of both plates, such that these sides are adjacent and attached to one another forming the side walls.

The flat tubes have two groups of protrusions in the main flat surfaces of one or both plates, those identified as first protrusions and those identified as second protrusions. The first protrusions have a smaller protrusion depth since it does not reach the opposite plate or the first protrusions of said opposite plate.

These first protrusions have the function of increasing the turbulence of the flow of the first fluid through the inside of the tube, as occurs in the state of the art.

The second protrusions are deeper since they reach the opposite plate. A particular way of reaching the opposite plate is for the two plates attached to one another to have second protrusions coinciding in layout such that each protrusion has a depth equivalent to half the tube height according to direction Z perpendicular to the main plane of the flat tube.

The contact between plates through the second protrusions is either contact by means of both plates being supported on one another, or contact by attachment, particularly by means of an attachment by welding. Said contact between plates through the second protrusions, either with or without being attached, establishes a barrier to the passage of the first fluid through the second protrusions. The first protrusions do not constitute a barrier to the passage of the first fluid but rather produce a disturbance of the flow favoring the occurrence of turbulent structures.

The barrier to the passage of the first fluid establishes that the second protrusions act as if they were a wall. The second protrusions are distributed such that they generate longitudinal channels inside the flat tube.

The channels formed in the flat tube are not only bound by the walls of the tubes. The channels are also formed by the second protrusions and the configuration of the walls of said channels depends on the configuration of the second protrusions. According to the invention, these second protrusions have either projections in the transverse direction or deviations in the transverse direction, or both, which disturb the flow of the first fluid when it passes through the channel. The disturbance occurs mainly in the transverse direction Y-Y′ instead of in direction Z as caused by the first protrusions, such that the combination of the disturbances in direction Z and the disturbances in transverse direction Y-Y′ results in a very important increase in turbulence, resulting in a much higher coefficient of heat transfer by convection, increasing the efficiency of the heat exchanger.

In the event that the plates through the second protrusions are not attached, but rather only supported, said support allows transmitting a load through the stack of flat tubes of the tube bundle. It is necessary to transmit the load through the stack when the second protrusions are not attached. The internal pressure of gas flowing through the inside of the tube tends to separate the plates configuring said tube, and it is therefore necessary to apply a force that compensates for this tendency to separate.

To prevent these plates from separating, a load is applied, for example, on the outer face of the tubes arranged as the first and last tubes of the stack, and said load is transmitted through the stack by means of outer projections of the tubes that are in contact with one another, such that the load is transmitted between tubes, preventing the movement of the plates.

The existence of the second protrusions in contact with and not welded to one another does not allow by itself preventing the plates making up the tube from separating or moving, the existence of the outer projections and for said projections to be in contact with one another therefore being necessary to transmit the load through the stack.

Additionally, the second protrusions also transmit the load from one plate to another through one and the same tube.

When the stack of tube bundle is surrounded by a shell, the outer projections are supported on the inner wall of the shell as means for generating stresses in the stack preventing the tubes from separating.

Particular ways of configuring the second protrusions are provided in the description of various embodiments below.

### DESCRIPTION OF THE DRAWINGS

These and other features and advantages of the invention will become more clearly understood from the following detailed description of a preferred embodiment given solely by way of illustrative, non-limiting example, in reference to the attached drawings.

FIG. 1A shows a perspective view of a heat exchanger according to an embodiment of the invention.

FIG. 1B shows a front view of the same heat exchanger seen from the inlet of the first fluid into the tubes of the tube bundle.

FIG. 2 shows a longitudinal section of the heat exchanger where the plane of section is parallel to the main plane of any of the tubes of the tube bundle.

FIGS. 3A and 3B show a front view of the inlet of a flat tube according to a first embodiment of the invention and a top view thereof, respectively.

FIGS. 4A and 4B show a front view of the inlet of a flat tube according to a second embodiment of the invention and a top view thereof, respectively.

FIGS. 5A and 5B show a front view of the inlet of a flat tube according to a third embodiment of the invention and a top view thereof, respectively. In this embodiment, the second protrusions incorporate communication windows between channels to allow compensating for pressures between tubes.

FIGS. 6A and 6B show a front view of the inlet of a flat tube according to a fourth embodiment of the invention and a top view thereof, respectively.

FIGS. 7A and 7B show a front view of the inlet of a flat tube according to a fifth embodiment of the invention and a top view thereof, respectively.

FIGS. 8A and 8B show a front view of the inlet of a flat tube according to a sixth embodiment of the invention and a top view thereof, respectively.

FIGS. 9A and 9B show a front view of the inlet of a flat tube according to a seventh embodiment of the invention and a top view thereof, respectively. In this embodiment, the disturbance of the flow according to the transverse direction is carried out by means of second protrusions with transverse deviations.

FIGS. 10A and 10B show a front view of the inlet of a flat tube according to an eighth embodiment of the invention and a top view thereof, respectively. In this embodiment, the disturbance of the flow according to the transverse direction is carried out by means of second protrusions with transverse deviations and window for compensating for pressures between channels.

FIGS. 11A and 11B show a front view of the inlet of a flat tube according to a ninth embodiment of the invention and a top view thereof, respectively. These figures show a particular embodiment which combines the pattern for the first protrusions like the one used in the first to fifth embodiments and a specific shape of the second protrusions. This combination of patterns has been proven to show particularly high efficiency values.

FIG. 12 shows a graph of the efficiency (Ef) with respect to the flow rate (Q) passing through the flat tube with measurements corresponding to three particular cases, a first case according to the state of the art without elements disturbing the longitudinal flow in the walls of the channels, and different second and third cases of embodiments of the invention showing curves with an efficiency considerably improved by the presence of the flow disturbing elements.

### DETAILED DESCRIPTION OF THE INVENTION

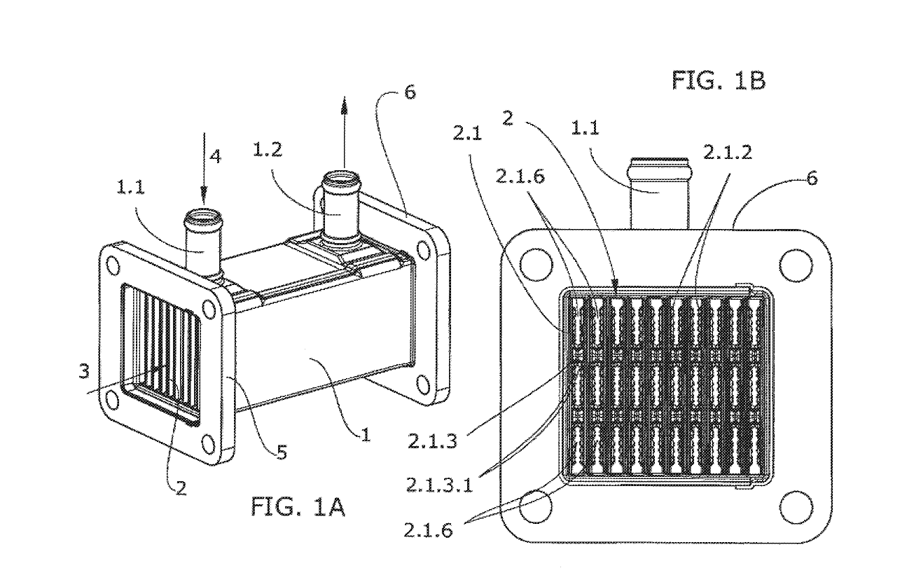

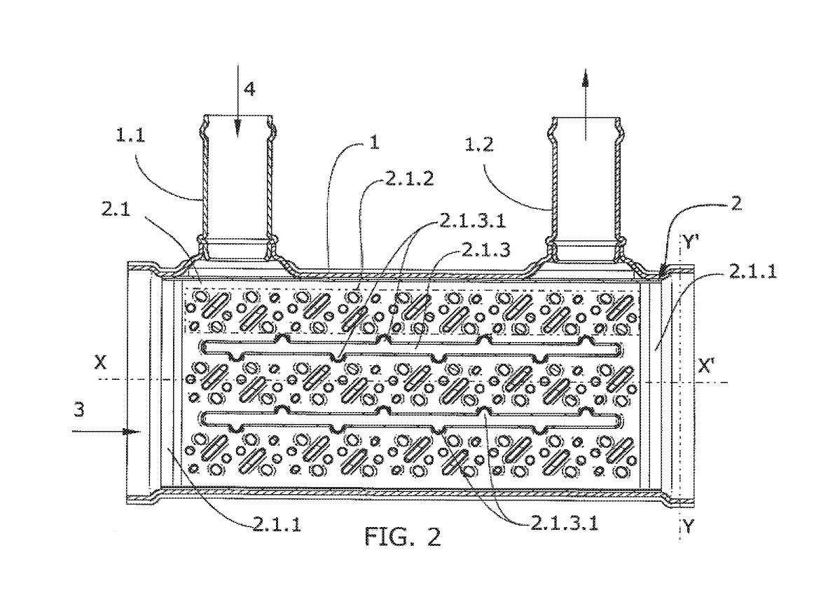

FIGS. 1A, 1B and 2 show a first embodiment of a heat exchanger for an EGR system according to the first inventive aspect, configured for the heat exchange between a first fluid (3) and a second fluid (4).

According to all the embodiments, the first fluid (3) is the hot gas coming from the exhaust conduit of an internal combustion engine, and the second fluid (4) is the liquid coolant of the engine.

FIG. 1A shows a perspective view of the first embodiment of the heat exchanger. The heat exchanger is formed by a shell (1) housing a tube bundle (2) having a flat configuration. According to the orientation of FIG. 1A and FIG. 1B, the second fluid (4) enters the shell (1) vertically through the inlet (1.1) for liquid coolant and exits through the outlet (1.2). Inside the shell (1), the flat tubes (2.1) also show a vertical arrangement such that the liquid coolant (4) passes between the tubes removing the heat given off by the first fluid (3), the hot gas.

The shell (1) externally has a flange (5, 6) at the inlet and the outlet of the first fluid (3) to allow attachment with the conduits conveying the first fluid (3).

The flat tubes (2.1) of the tube bundle (2) are configured by means of two flat plates attached to one another. Each of the plates shows bent sides (2.1.5) generating the walls of the flat tube (2.1).

The wall or bent side (2.1.5) formed by the bending in one of the plates is located adjacent to the wall or bent side (2.1.5) formed by the bending of the other plate such that the inner face of one wall is attached to the outer wall of the wall of the other plate.

The main surface of the plate generates the larger faces of the flat tube (2.1) and the bent sides (2.1.5) generate the smaller sides of said flat tube (2.1).

At the ends of the flat tubes (2.1) there is an expansion (2.1.1) in the direction of the stack (Z) of the flat tubes. The expansion is produced by a greater height of the bent side (2.1.5), and, in the larger faces, a double step leading to the section of the flat tube (2.1) being greater in this expansion (2.1.1) because the distance between the larger faces is increased.

In the stack of flat tubes (2.1) forming the tube bundle (2), the support between the flat tubes (2.1) is produced in this expansion (2.1.1), and in the rest of the length of the flat tube (2.1) a space that allows the passage of the second fluid (4) is established.

FIG. 1B shows the inlet or outlet of the flat tubes (2.1) and how the expansion (2.1.1) determines that the entire inlet area of the tube bundle (2) corresponds with the sum of the inlet areas of the flat tubes (2.1) except the thickness of the plates forming the walls of the flat tubes (2.1). This configuration reduces pressure drops due to the reduction of the passage section to a minimum.

FIG. 2 shows a longitudinal section of the heat exchanger where the plane of section is parallel to the flat tubes (2.1). In this section, the flat tubes (2.1) are shown in contact with the inner face of the shell (1) to force the liquid coolant (3) to pass between the flat tubes (2).

The flat tubes (2.1) have first protrusions (2.1.2) distributed along the longitudinal direction X-X′. These first protrusions (2.1.2) produce disturbances on the flow passing through the inside of the flat tube (2.1) in the direction (Z) of the stack increasing the turbulence and therefore increasing the heat transfer coefficient between the hot gas (3) and the surface of said flat tube (2.1).

According to various embodiments, these first protrusions (2.1.2) form patterns that are repeated along the length of the flat tube (2.1).

According to the invention, the flat tubes have one or more second protrusions (2.1.3) deeper than the first protrusions (2.1.2), such that they reach the opposite plate. They either reach the opposite plate because the depth of the second protrusions (2.1.3) is such that they cover the section of the flat tube (2.1), or because the second protrusions (2.1.3) of both sides of the flat tube (2.1) have a depth such that both are in contact with one another. According to this second option and according to an embodiment, the configuration according to the main plane of the flat tube (2.1) is symmetrical so that they coincide when the plates generating the flat tube (2.1) are placed opposite one another.

The second protrusions (2.1.3) are attached to the other plate by welding and form channels (2.1.6). FIG. 1B shows through the inside of the flat tube (2.1) how the first protrusions (2.1.2) reduce the section of the flat tube (2.1) without reaching the opposite side, and it also shows the second protrusions (2.1.3) of the plates forming the flat tube in contact with one another forming channels (2.1.6).

The tubes built according to the state of the art, where a pattern of protrusions distributed on the two main faces is produced from a plate by deep-drawing and by bending, which have both these larger faces with the protrusions and the side walls, do not allow the side faces to have patterns of protrusions since it is necessary to have a support surface for the rollers drawing the plate to be bent.

For that reason, all the protrusions cause disturbances only in the perpendicular direction with respect to the flat tube, and show protrusions that must be spaced from the walls to favor folding along the bending line of the wall.

According to the invention, the flat tube (2.1) has two or more longitudinal channels (2.1.6) where each of the channels is equivalent to a tube according to the state of the art. Nevertheless, the turbulent flow inside the channels is different from the flow in the tubes of the state of the art.

One or more walls of the channels (2.1.6) of the flat tube (2.1) has either projections (2.1.3.1) in the transverse direction (Y-Y′) or deviations (2.1.3.2) in the transverse direction (Y-Y′), or both, for disturbing the hot gas flow in the transverse direction (Y-Y′). These projections emerge from the second protrusions (2.1.3) in the transverse direction (Y-Y′), increasing the turbulence with disturbances perpendicular to the disturbances produced by the first protrusions (2.1.3). It is this coupled effect that very significantly increases the coefficient of heat transfer with respect to the solutions of the state of the art.

FIG. 2 shows an embodiment of the second protrusions (2.1.3) having a longitudinal configuration, according to the longitudinal direction X-X′ of the flat tube (2.1), with projections (2.1.3.1) also longitudinally distributed on both sides of the second protrusion (2.1.3) in an alternating manner. These projections produce disturbances of the hot gas flow generating velocity components parallel to the main plane of the flat tube (2.1) and towards the center of the channel (2.1.6). These fluctuations aimed at the center of the channel (2.1.6) produce pressure variations on the first protrusions (2.1.2) which in turn increase their effect of disturbing the flow in the perpendicular direction with respect to the main plane of the flat tube (2.1).

It has been found that this synergistic effect is very high and it would be impossible to obtain with current techniques for manufacturing tubes with notches.

The pattern shown by the distribution of the first protrusions (2.1.2) in FIG. 2 is formed by the combination of two alternating slanted alignments, a first alignment of circular- or almost circular-shaped protrusions where the dimensions of the protrusions of the ends is greater and a second alignment of a first protrusion having a greater elongated length and a second protrusion having a circular or almost circular section.

In the first oblique alignment, the protrusions of the ends have larger dimensions, and the protrusions which are not ends are slightly shifted with respect to the oblique direction of this alignment. The second alignment of protrusions, or pair of protrusions, one having a greater elongated length and the other having an almost circular section, alternate the side on which they are located following the longitudinal direction X-X′.

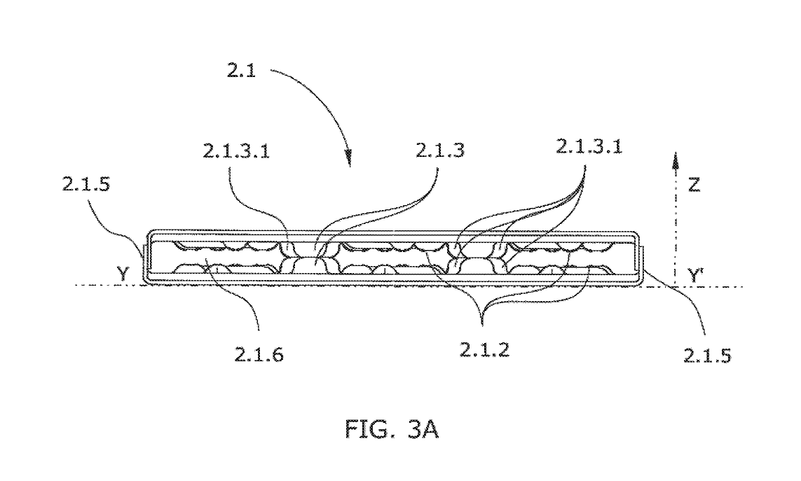

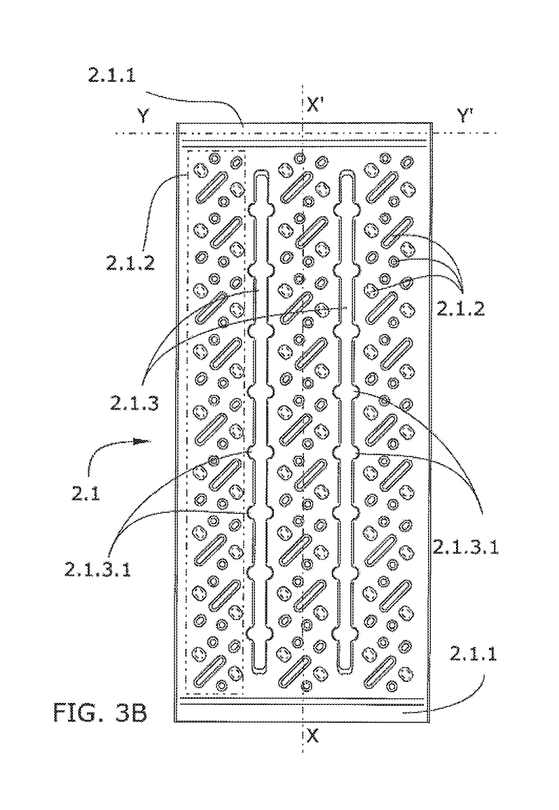

This pattern of first protrusions (2.1.2) is the one particularly used also in the embodiments shown in FIGS. 3(A-B) to 7(A-B) and 11(A-B).

Nevertheless, the other drawings show other examples of flat tubes (2.1) with specific patterns of both the first protrusions (2.1.2) and specific shapes of the second protrusions (2.1.3) where, in any case, the combination of the pattern in the first protrusions (2.1.2) and the shape of the second protrusions (2.1.3) has been found to generate a higher synergistic effect, generating greater turbulence causing the heat transfer obtained to be greater, the efficiency of the heat exchanger therefore being much higher.

FIG. 3A shows a front view of a detail of the inlet of the flat tube (2.1) of a first embodiment, in addition to the one already shown in the preceding drawings, together with FIG. 3B which shows a top view of the same flat tube (2.1).

FIG. 3A indicates the direction (Z) of the stack according to the expansion (2.1.1) and the transverse direction (Y-Y′) in which the disturbances are produced by the presence of the projections (2.1.3.1) of the second protrusions (2.1.3).

As shown in FIG. 3B, in this embodiment the second protrusions (2.1.3) longitudinally extend continuously dividing the flat tube (2.1) into three longitudinal channels (2.1.6). Each of the second protrusions (2.1.3) has two projections (2.1.3.1) that coincide according to the longitudinal direction X-X′ and are arranged symmetrically on both sides of the second protrusion (2.1.3).

In this embodiment, the projections (2.1.3.1) of the second protrusions (2.1.3) coincide with the ends of the channels that are formed between the oblique alignments of the patterns of the first protrusions (2.1.2).

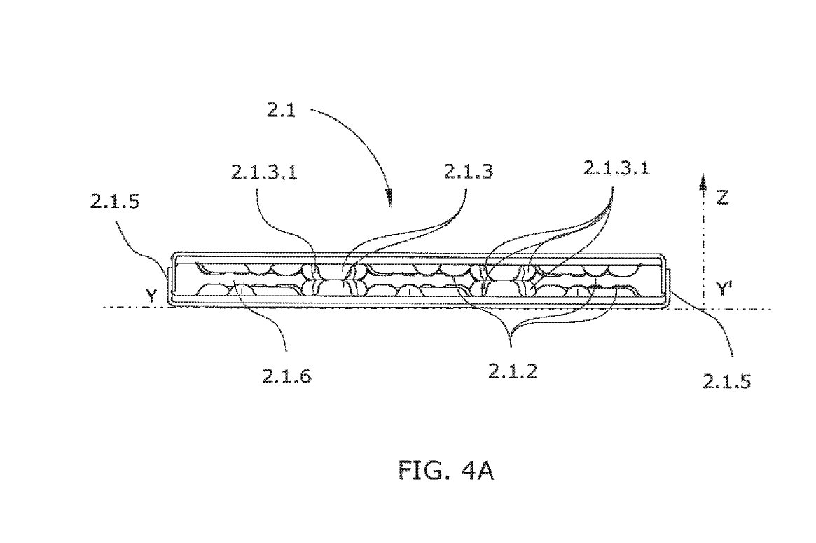

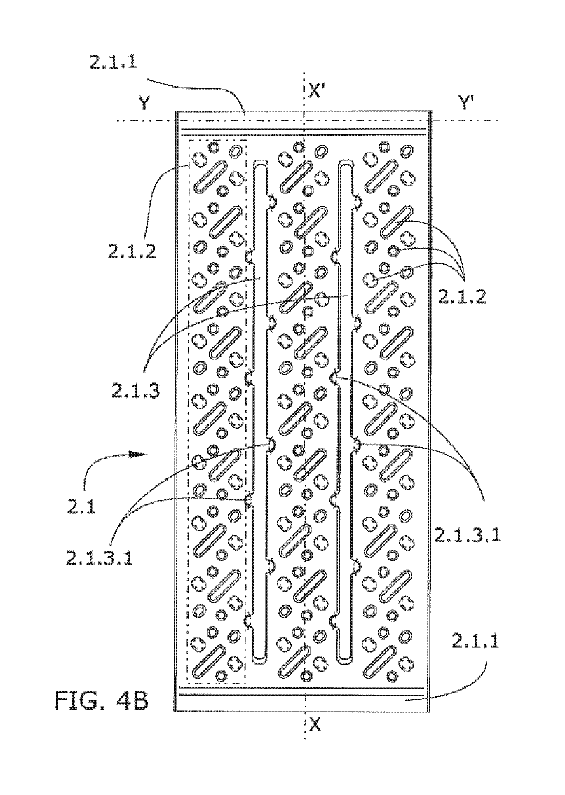

FIGS. 4A and 4B show a second embodiment in which the pattern used in the first protrusions coincides with the pattern described for the preceding example. Nevertheless, the projections (2.1.3.1) of the second protrusions are located in an alternating manner on both sides of the longitudinal direction X-X′ along which the second protrusion (2.1.3) continuously extends.

In this embodiment, the projections (2.1.3.1) of the second protrusions (2.1.3) also coincide with the channels that are formed between the oblique alignments of the patterns of the first protrusions (2.1.2), which allows inducing fluctuations of the flow established between these channels. This embodiment is similar to the preceding embodiment where part of the projections (2.1.3.1) has been eliminated, reducing the pressure drop of the hot gas, maintaining the disturbance of the flow according to the transverse direction (Y-Y′).

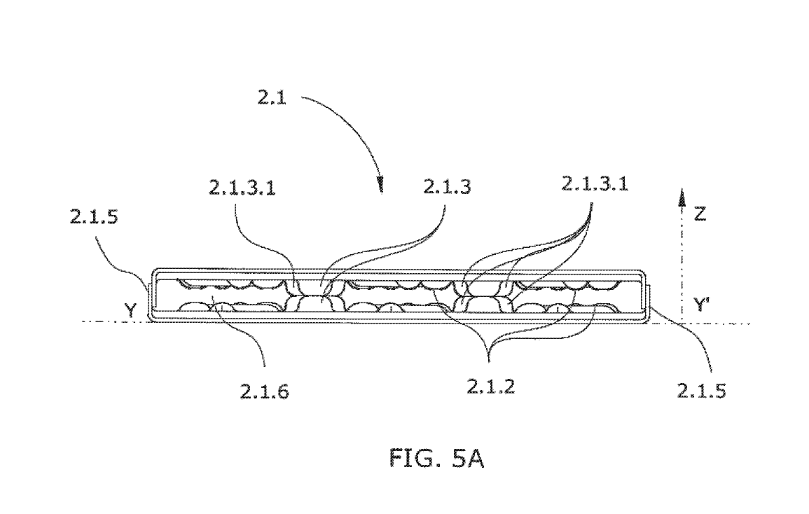

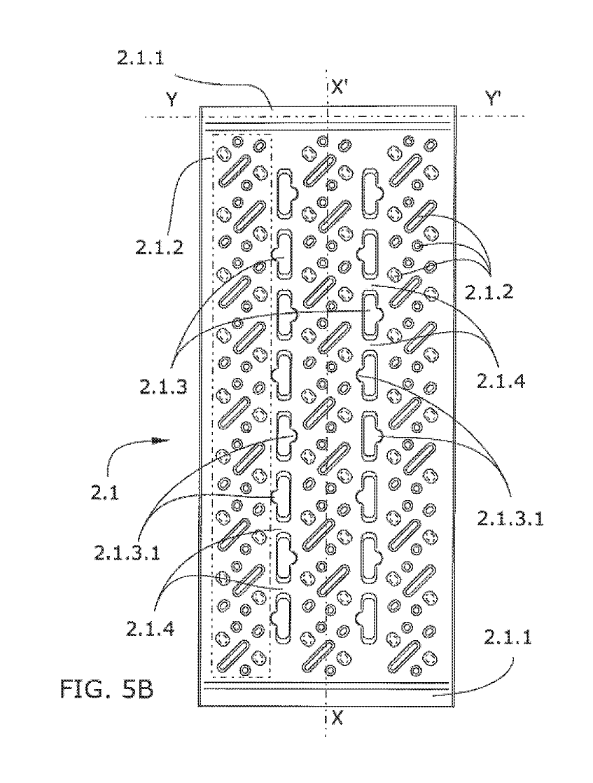

FIGS. 5A and 5B show a third embodiment similar to the preceding embodiment. It is similar to the preceding embodiment in that it uses the same pattern of first protrusions (2.1.2), and the second protrusions (2.1.3) extend longitudinally with projections (2.1.3.1) alternating on both sides of the longitudinal direction (X-X′).

In this embodiment, the second protrusions (2.1.3) are not continuous since they show windows (2.1.4) that allow the fluid communication of the hot gas between longitudinal channels (2.1.6). This fluid communication allows compensating for pressures differences between channels (2.1.6) not only because there are different conditions at the inlet but also because the heat transfer changes the thermodynamic variables of the hot gas and can show different pressures. The presence of the windows (2.1.4) homogenizes conditions between channels (2.1.6) without affecting the transverse disturbances caused by the projections (2.1.3.1) of the second protrusions (2.1.3).

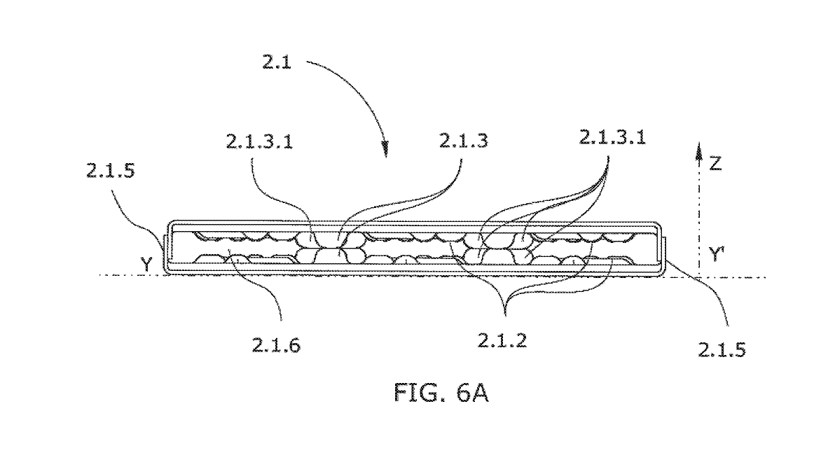

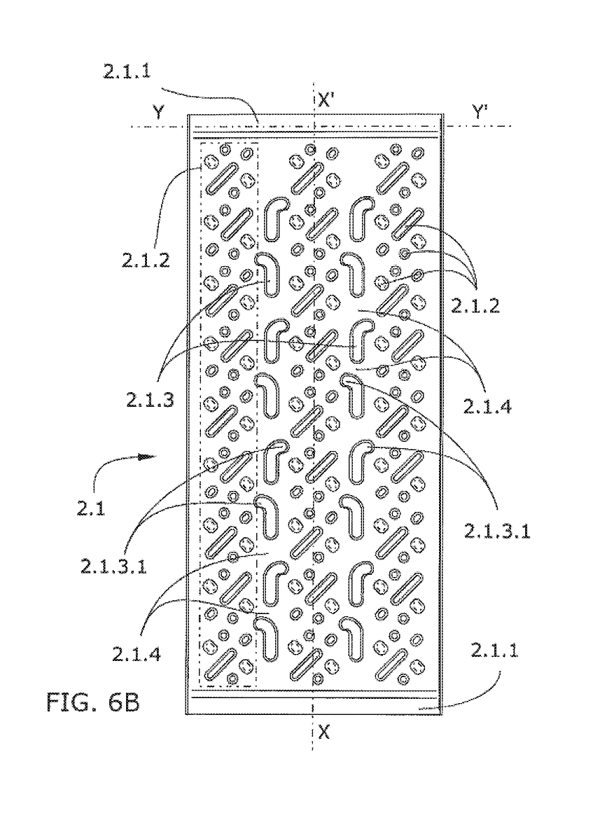

FIGS. 6A and 6B show a new embodiment in which the pattern of the first protrusions (2.1.2) coincides with the pattern shown in the three preceding embodiments.

The second protrusions (2.1.3) form two longitudinal alignments, each alignment being formed by longitudinal segments with an end in the form of a transverse projection (2.1.3.1) alternating on both sides of the longitudinal direction (X-X′).

These transverse projections (2.1.3.1) located at the end of the segment are configured as a curved, cane-like prolongation, generating a smooth transition to prevent the presence of small stagnation regions which generate regions of thermal fatigue due to the presence of hot points, and to make it easier to stamp the plate adopting this shape.

This embodiment also shows windows (2.1.4) between segments for compensating for pressures between longitudinal channels (2.1.6).

In this embodiment, the transverse disturbances caused by the projections (2.1.3.1) are larger than in the preceding examples since the projection (2.1.3.1) is located at the end of the segment and right before the window (2.1.4).

Not only is the transverse disturbance due to the existence of the projection (2.1.3.1), but its end position with a curved termination due to the cane shape also causes a small suction effect in the adjacent channel (2.1.6) that deflects the flow towards the channel (2.1.6) towards which the projection (2.1.3.1) emerges. Although the window (2.1.4) favors this effect according to the transverse direction (Y-Y′), said window maintains its function of compensating for pressure between channels (2.1.6).

This disturbing effect according to the transverse direction (Y-Y′) alternates along the longitudinal direction (X-X′) such that the turbulence caused is developed in a short length of the flat tube (2.1), subsequently enhanced by the first protrusions (2.1.2) according to the pattern shown.

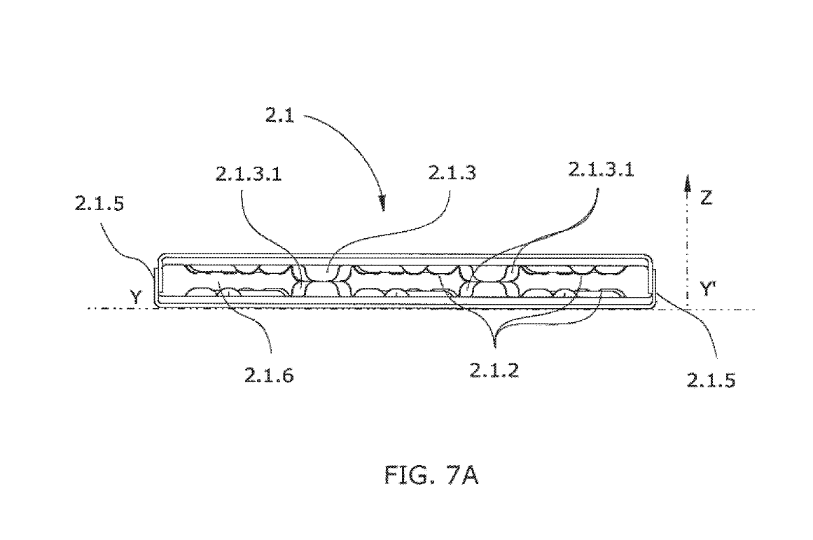

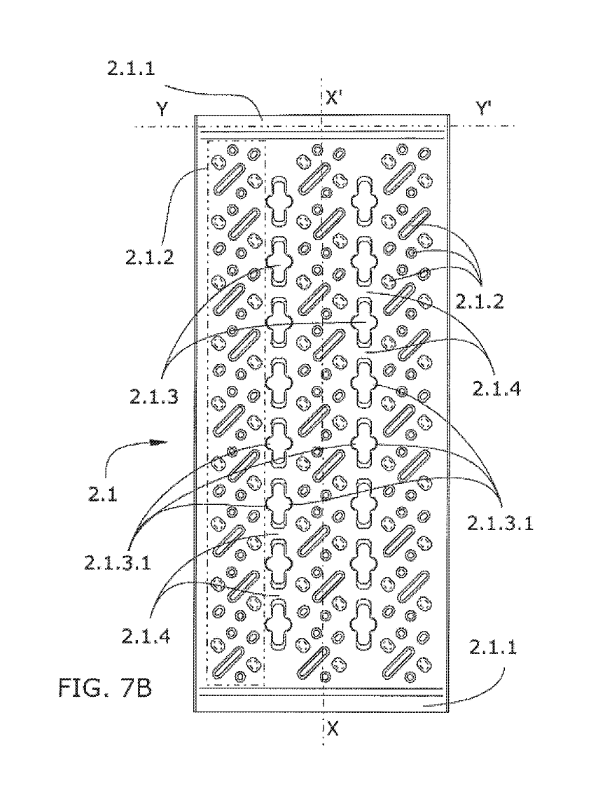

FIGS. 7A and 7B show a fifth embodiment maintaining the pattern of the first protrusions (2.1.2), where the second protrusions are formed by two longitudinal alignments, and each alignment of second protrusions (2.1.3) has segments with centered projections (2.1.3.1) located on both sides of said segment.

Between the segments of each alignment of second protrusions (2.1.3) there is a window (2.1.4) for compensating for pressures between channels (2.1.6). A homogenous flow is achieved in this combination of first protrusions (2.1.2) with the pattern shown and second protrusions (2.1.3) with a high coefficient of heat transfer due to the turbulence caused by the pattern of first protrusions (2.1.2) enhanced by the transverse projections (2.1.3.1), but without important fluctuations between channels (2.1.6) due to the symmetry of the projections (2.1.3.1) along the longitudinal direction (X-X′). The windows (2.1.6) favor to a greater extent the homogeneity in the turbulence between channels (2.1.6) due to the fact that that it allows compensating for pressures.

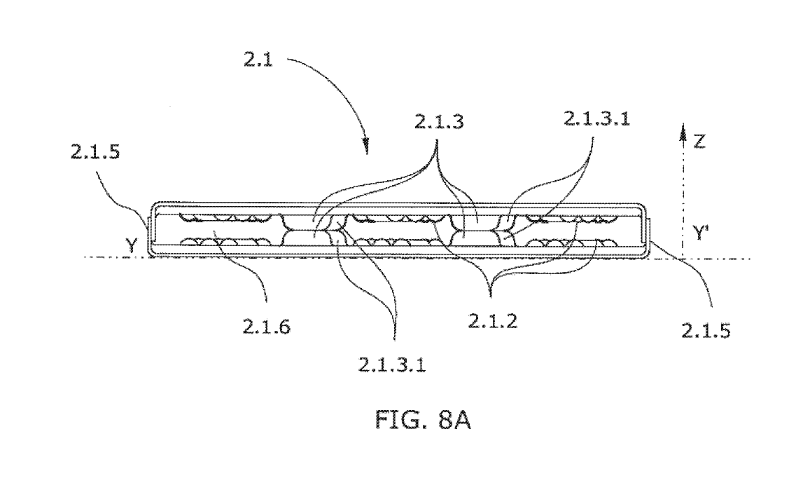

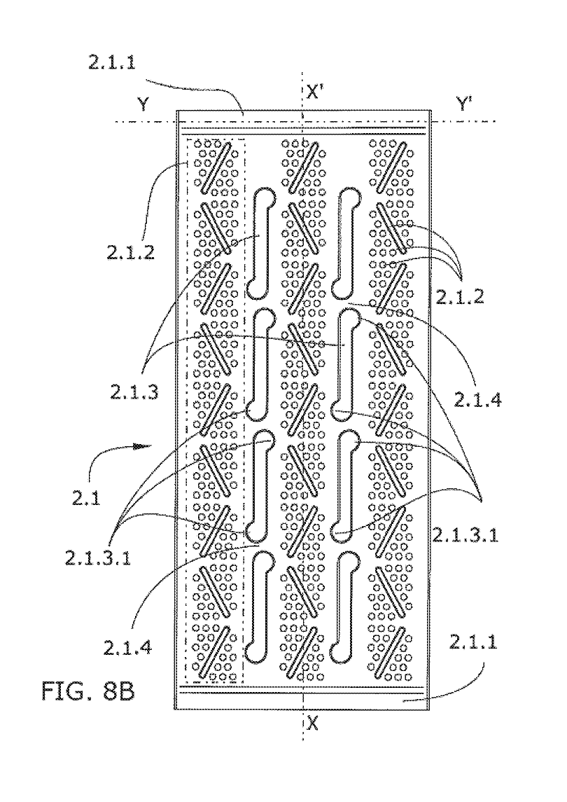

FIGS. 8A, 8B, 9A, 9B, 10A and 10B show a sixth, seventh and eighth embodiment sharing a pattern of first protrusions (2.1.2) different from the preceding ones.

This second pattern of first protrusions (2.1.2) is formed by protrusions in the form of an elongated segment being arranged in a slanted manner alternating the inclination on both sides of the longitudinal direction (X-X′). The two triangular areas this elongated segment leaves on both sides are filled with circular-shaped protrusions which disturb the flow in an isolated manner according to a very rough finish.

In the sixth embodiment shown in FIGS. 8A and 8B, the second protrusions (2.1.3) are formed by elongated segments, oriented according to the longitudinal direction (X-X′), which have a greater width than the elongated segments of the pattern of the first protrusions (2.1.2).

At the ends of these elongated segments of the second protrusions (2.1.3) there are circular thickened portions deviated towards one side according to the longitudinal direction (X-X′) and deviated towards the opposite side at the other end, generating projections (2.1.3.1) at both ends which disturb the hot gas flow in the transverse direction (Y-Y′).

Between consecutive elongated segments of the second protrusions (2.1.3) there are windows (2.1.4) arranged that allow compensating for the pressure between the longitudinal channels (2.1.6) defined by these second protrusions (2.1.3).

The alternating positions of the projections (2.1.3.1) on both sides of the ends of the long segments of the second protrusions (2.1.3) generate windows (2.1.4) with a specific inclination generating a slight tendency of the hot gas flow to pass from one channel (2.1.6) to the adjacent one. In all the windows (2.1.4), this tendency is the same transverse direction (Y-Y′). This configuration is suitable for increasing the tendency to compensate between channels (2.1.6) when the inlet flow of the hot gas has a specific transverse velocity component that should be compensated for.

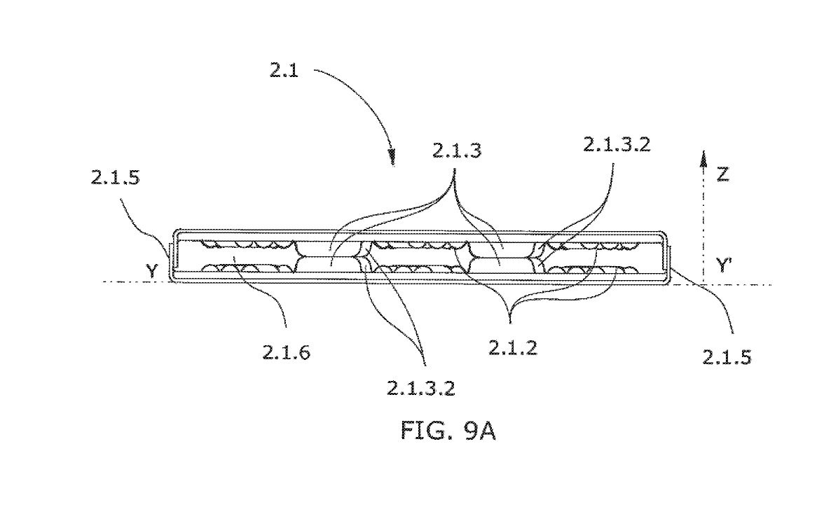

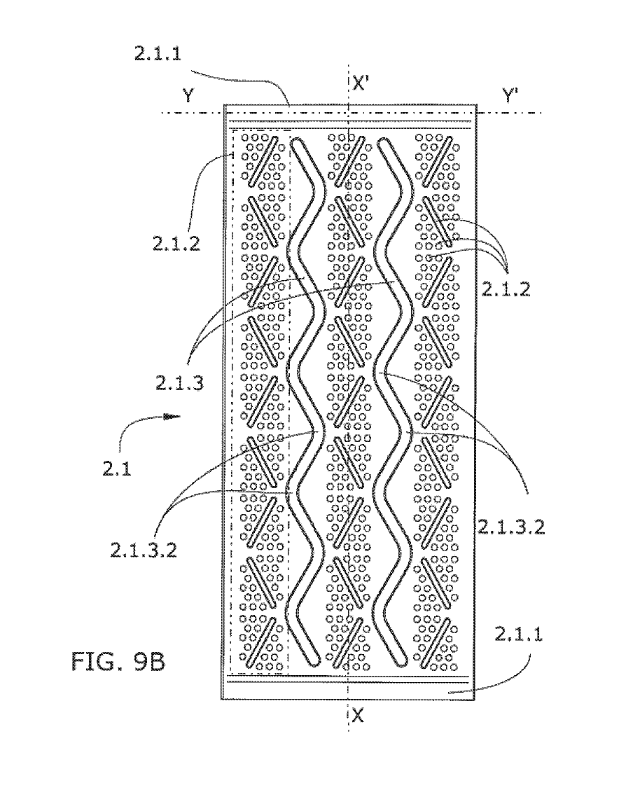

The seventh embodiment is shown in FIGS. 9A and 9B where the pattern of first protrusions (2.1.2) is the same as the one in the preceding example.

In this embodiment, the second protrusions (2.1.3) are configured by means of protrusions extending according to the longitudinal direction showing alternating deviations (2.1.3.2) on both sides of the longitudinal direction X-X′ causing disturbances in the flow according to the transverse direction (Y-Y′).

In this embodiment, each flat tube (2.1) shows two second protrusions (2.1.3) forming three longitudinal channels (2.1.6), where both second protrusions (2.1.3) show the same deviations (2.1.3.2) according to the longitudinal direction. With this configuration, the central longitudinal channel (2.1.6) shows deviations of the flow according to the transverse direction (Y-Y′) caused by the deviations (2.1.3.2) of both sides.

In addition, the longitudinal channels (2.1.6) located on the sides of the flat tube (2.1) have on one side the wall of the flat tube (2.1) formed by the bent sides (2.1.5) with a straight configuration, and on the other side the deviation (2.1.3.2) of the second protrusion (2.1.3). In addition to causing a transverse deviation of the hot gas flow, these deviations (2.1.3.2) of the second protrusions (2.1.3) impose changes in the section of these longitudinal channels (2.1.6) located on the sides.

The way to disturb flow transversely in the two side longitudinal channels (2.1.6) is different from the way to disturb the flow in the central longitudinal channel (2.1.6) where the sides show greater resistance to the passage of the flow compensating for the preferred paths that are formed by the spacing of the pattern of first protrusions (2.1.2) and the walls formed by the bent sides (2.1.5) of the flat tube (2.1). As a result, the efficiency of the flat tube (2.1) increases.

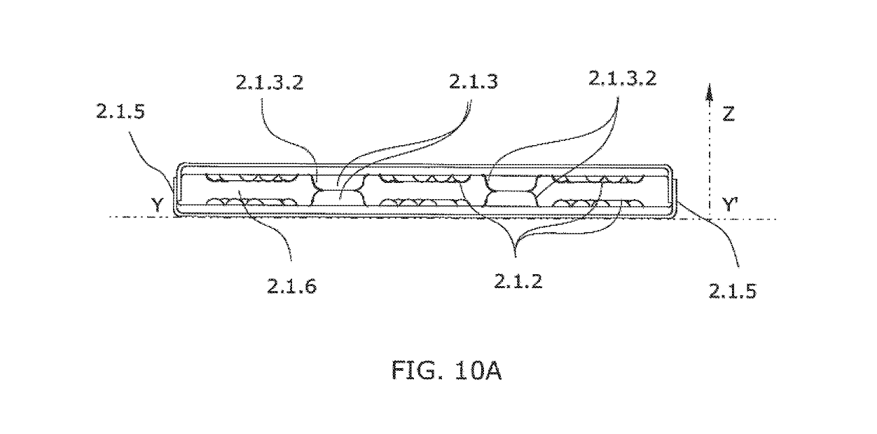

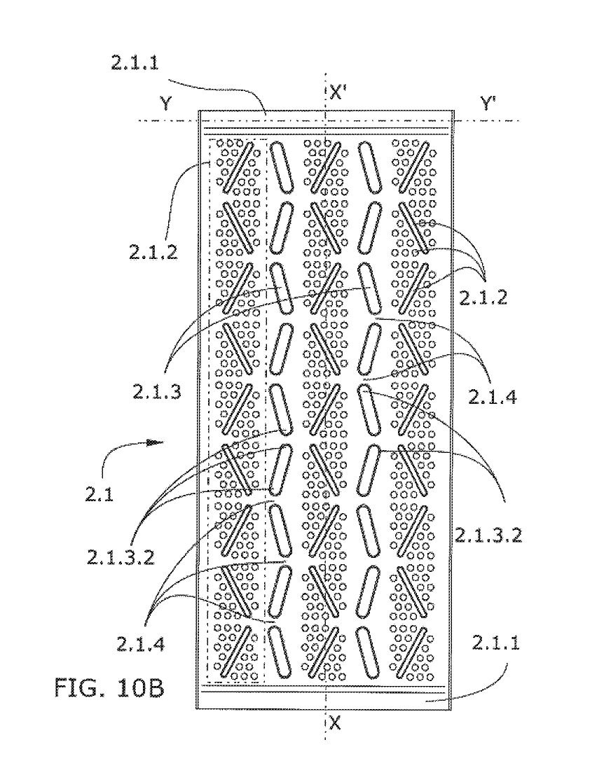

FIGS. 10A and 10B show an eighth embodiment sharing the pattern of first protrusions (2.1.2) with the two preceding embodiments.

In this embodiment, the second protrusions (2.1.3) form two alignments with segments being arranged in a slanted manner with the inclination with respect to the alternate longitudinal direction (X-X′). In this embodiment, the segments have a length similar to that of the slanted segments of the pattern of first protrusions (2.1.2), located in the same longitudinal position and with a smaller inclination solely for establishing a deviation (2.1.3.2) on both sides of the longitudinal channels (2.1.6) it forms.

It has been experimentally found that the best results are obtained with angles of the oblique segments of the second protrusions (2.1.3) with respect to the longitudinal direction X-X′ comprised in the range of [5°,45° ], preferably in the range of [10°,30° ], and more preferably in a range of [15°,20° ].

Between these elongated oblique segments there are windows (2.1.4) that allow compensating for the pressure between the longitudinal channels (2.1.6).

The influence of the transverse deviations caused by the second protrusions (2.1.3) in the flow established in the channels (2.1.6) by the first protrusions (2.1.2) has been proven to offer an unusually high efficiency.

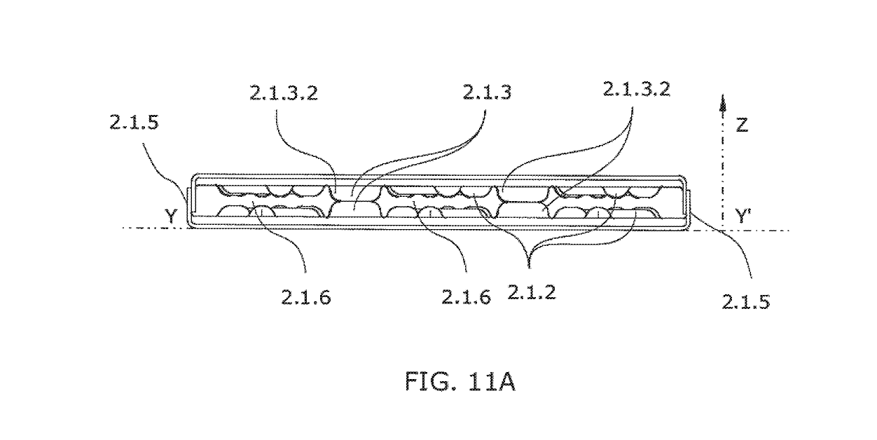

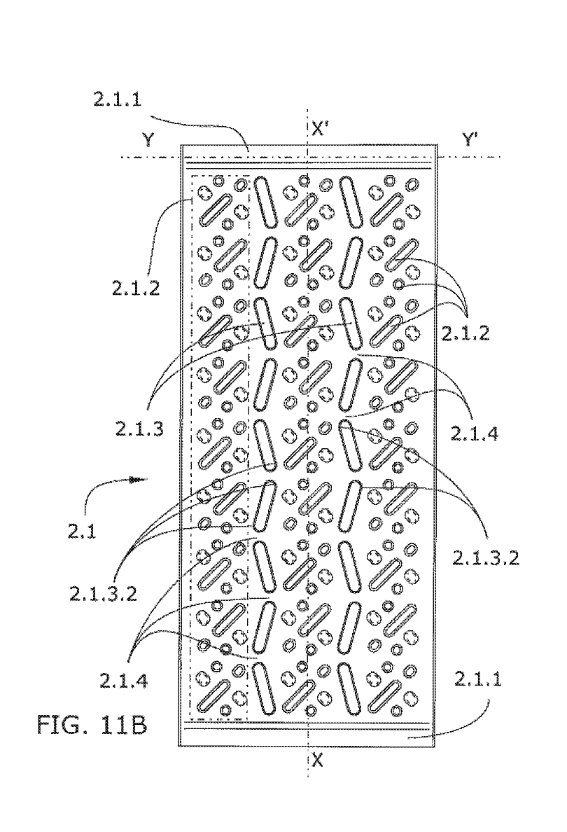

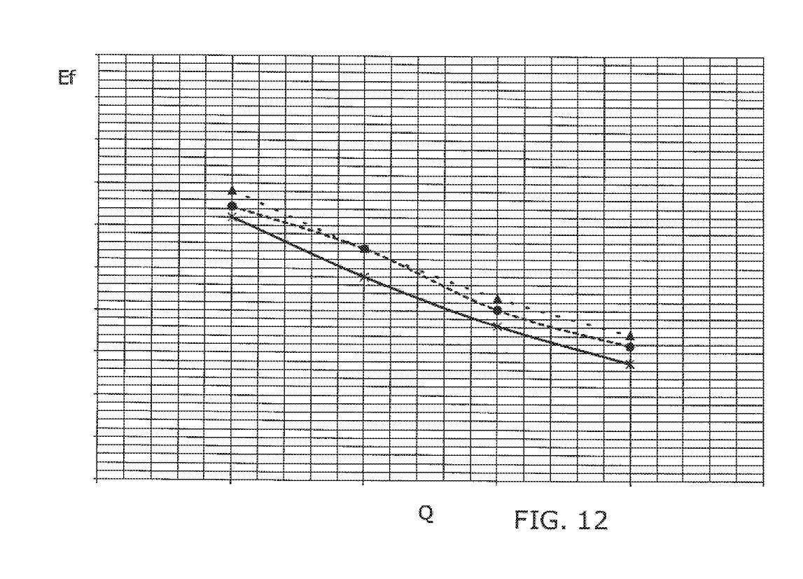

The pattern of first protrusions (2.1.2) shown in FIGS. 2 to 7 and in FIG. 11, and the pattern of first protrusions (2.1.2) shown in FIGS. 8 to 10 are interchangeable although the described combinations show the advantages indicated when they are combined with the particular configuration of the second protrusions (2.1.3) of each specific example.

In all the embodiments, the first protrusions (2.1.2) are aimed towards the inside of the tube (2.1) for disturbing the flow of the first fluid (3). Nevertheless, in any of the embodiments it is possible to include one or more projections aimed towards the outside of the tube (2.1) such that, when stacked, these projections are in contact either with the projections of the adjacent tube or directly in contact with the wall of the tube. The set of projections in contact with one another transmit stresses perpendicular to the main plane of the flat tube (2.1), preventing vibrations and compensating for the stresses generated by the pressure of the first fluid (3) inside the tube (2.1) which tends to expand the flat tubes (2.1).

FIGS. 11A and 11B show a ninth embodiment of the invention and a top view thereof, respectively. In this embodiment, two specific patterns for the configuration of the first protrusions (2.1.2) and for the configuration of the second protrusions (2.1.3) are combined, the pattern of said first protrusions (2.1.2) being the one shown in the examples reproduced in FIGS. 2 to 7.

In this embodiment, the second protrusions (2.1.3) are longitudinal segments with deviations (2.1.3.2) with respect to the longitudinal direction (X-X′) according to alternating inclined segments and with windows (2.1.4) between each other.

The transverse disturbance of the flow caused by the deviations (2.1.3.2) mainly affects the flow circulating through the channels (2.1.6) in which the first protrusions (2.1.2) are located. The disturbances already caused by the first protrusions have a larger or smaller effect on the efficiency of the flat tube (2.1) depending on the evolution of the turbulence along its passage through the tube and therefore on the history of the disturbances already imposed upstream.

The cumulative effect on the disturbance of the flow through all the projections the fluid encounters along its passage through the tube depends on a large number of variables, such as the shape of each first protrusion (2.1.2), the pattern used or the dimensions thereof, for example.

The same projections, the pattern of which is slightly modified, can generate small preferred channels which substantially modify the mean velocity field, the interaction with the first protrusions, and therefore the efficiency of the tube (2.1).

This same situation occurs with the second protrusions (2.1.3) where it is impossible to establish guidelines that determine an optimal shape and distribution of the protrusions (2.1.2, 2.1.3), where the efficiency of the tube is the target function.

This situation is common in all the particular embodiments described above. Nevertheless, it has been experimentally found that combining the patterns for the first protrusions (2.1.2) and second protrusions (2.1.3) configured as shown in FIGS. 10A, 10B, 11A and 11B establishes an efficiency value that is higher than in the preceding cases.

FIG. 12 shows a graph with three curves representing the efficiency (Ef) of the tube in the heat exchange with respect to the flow rate (Q) for three configurations of flat tubes (2.1). The object of this graph is to show the increase in efficiency in a flat tube due to the synergistic effect between the first protrusions (2.1.2) and the second protrusions (2.1.3) according to the invention.

The graph depicts three examples of flat tubes (2.1), a first curve identified in a continuous line and with crosses corresponds to a flat tube according to the state of the art in which the use of patterns for disturbing the flow in the direction (Z) of the stack and of continuous longitudinal protrusions free of projections is combined to create three internal channels in this case.

The values of the third curve shown in FIG. 12, identified with a discontinuous line and triangles, correspond to the flat tube (2.1) of the eighth embodiment described above with the aid of FIGS. 10A and 10B. The pattern of first protrusions (2.1.2) of this eighth embodiment is the one that is used for the first flat tube according to the state of the art, the values of which are represented in the first curve, and also for the second tube, the values of which are represented in the second curve, identified with a discontinuous line and circles.

This second tube combines this pattern for the first protrusions (2.1.2) with a configuration of the second protrusions (2.1.3) like the one described in the third example shown in FIGS. 5A and 5B, except with more pronounced projections (2.1.3.1).

In FIG. 12, the second curve is identified by a discontinuous line and circles on same, and the third curve is identified by a discontinuous line, with a larger gap between dashes than the second curve, and triangles located on same.

The use of the same pattern of first protrusions (2.1.2) allows comparing the changes in the efficiency values of the tubes when the only changes are the introduction either of projections (2.1.3.1) in the transverse direction (Y-Y′) or deviations (2.1.3.2), according to the invention.

The results obtained experimentally show a greater pressure drop that can be explained due to an additional element being arranged against the passage of the flow, i.e., either projections (2.1.3.1) extending in the transverse direction (Y-Y′) or deviations (2.1.3.2), but which is compensated for with a considerable improvement in efficiency. This improvement in efficiency is achieved without increasing the size of the tube bundle (2), so it is possible to either reduce the size of the heat exchange device or to provide a device with a higher heat exchange capacity in the same space.

1. A heat exchanger for an EGR system adapted for the heat exchange between a first fluid (3), the exhaust gas of an internal combustion engine, and a second fluid (4), a liquid coolant, comprising:
a shell (1) with an inlet (1.1) and an outlet (1.2) for the second fluid (4);
a heat exchange tube bundle (2) housed inside the shell (1) formed by stacking flat tubes (2.1) having a rectangular section, arranged parallel to one another, extending according to a longitudinal direction (X-X′) between an inlet of the first fluid (3) and an outlet of the first fluid (3);
wherein the space between the exchange tube bundle (2) and the shell (1) is configured for the passage of the second fluid (4); and
wherein the flat tubes (2.1) of the tube bundle (2) comprise an expansion (2.1.1), in the direction of the stack (Z) of the tube bundle (2), at the ends thereof to establish a passage space between tubes (2.1) for the second fluid (4);
and wherein at least one of the tubes (2.1) of the bundle tubes (2):
is configured by attaching two flat plates with bent sides (2.1.5), such that an inner face of the bent side (2.1.5) of a plate is attached to the outer face of the bent side (2.1.5) of the other plate;
wherein both plates have groups of first protrusions (2.1.2) distributed along the longitudinal direction (X-X′),
wherein at least one plate has one or more second protrusions (2.1.3) deeper than the first protrusions (2.1.2) that reach the opposite plate, both plates being either in contact with one another or being attached by means of the at least one second protrusions, forming longitudinal channels (2.1.6) inside the flat tube (2.1),
and wherein, given the transverse direction (Y-Y′) as the perpendicular direction with respect to the longitudinal direction (X-X′) contained in the main plane of the flat tube (2.1), the second protrusion or protrusions (2.1.3) have either projections (2.1.3.1) in the transverse direction (Y-Y′) or deviations (2.1.3.2) in the transverse direction (Y-Y′), or both, for disturbing the flow of the first fluid (3) in the transverse direction (Y-Y′) from the walls of the channel (2.1.6) formed by said second protrusions (2.1.3).

2. The heat exchanger according to claim 1, wherein the second protrusions (2.1.3) of the at least one tube (2.1) of the tube bundle (2) forming the channels (2.1.6) are distributed longitudinally in both plates, and wherein said second protrusions (2.1.3) are complementary.

3. The heat exchanger according to claim 1, wherein the second protrusions (2.1.3) comprise projections (2.1.3.1) on both sides of the longitudinal direction (X-X′) arranged symmetrically.

4. The heat exchanger according to claim 1, wherein the second protrusions (2.1.3) comprise projections (2.1.3.1) on both sides that are offset according to the longitudinal direction (X-X′).

5. The heat exchanger according to claim 1, wherein the second protrusions (2.1.3) have windows (2.1.4) for compensating for the pressure between channels (2.1.6).

6. The heat exchanger according to claim 1, wherein the second protrusions (2.1.3) are longitudinal segments with an end in the form of a transverse projection alternating on both sides of the longitudinal direction (X-X′).

7. The heat exchanger according to claim 1, wherein the second protrusions (2.1.3) are longitudinal segments with an end in the form of a transverse projection located on one side of the longitudinal direction (X-X′).

8. The heat exchanger according to claim 7, wherein the opposite end of the second protrusions (2.1.3) comprises a transverse projection located on the opposite side with respect to the longitudinal direction X-X′.

9. The heat exchanger according to claim 1, wherein the second protrusions (2.1.3) are longitudinal segments with transverse projections (2.1.3.1) centered in each longitudinal segment, extending according to the longitudinal direction (X-X′), and alternating on both sides of said longitudinal direction (X-X′).

10. The heat exchanger according to claim 1, wherein the second protrusions (2.1.3) are longitudinal segments with transverse projections (2.1.3.1) centered in each longitudinal segment, according to the longitudinal direction (X-X′), and located on both sides of the longitudinal direction (X-X′).

11. The heat exchanger according to claim 1, wherein the second protrusions (2.1.3) are longitudinal segments with deviations (2.1.3.2) with respect to the longitudinal direction (X-X′) in an alternating manner according to a winding path.

12. The heat exchanger according to claim 11, wherein the second protrusions (2.1.3) have windows (2.1.4) for compensating for the pressure between channels (2.1.6) and wherein the second protrusions (2.1.3) are longitudinal segments with deviations (2.1.3.2) with respect to the longitudinal direction (X-X′) according to alternating inclined segments and with windows (2.1.4) between one another.

13. The heat exchanger according to claim 12, wherein the pattern of the first protrusions (2.1.2) comprises protrusions in the form of an elongated segment, said elongated segment being arranged in a oblique manner, wherein
the protrusions in the form of an elongated segment are distributed longitudinally such that the inclination thereof alternates on both sides of the longitudinal direction X-X′, triangular areas being formed on each side of the elongated segments; and
said triangular areas being filled by circular-shaped protrusions.

14. The heat exchanger according to claim 1, wherein the flat tubes (2.1) of the tube bundle (2) comprise projections such that they are configured either for supporting one another in the stack or are configured for being directly supported on the wall of the adjacent tube to prevent expansion due to the pressure of the first fluid (3).

15. An EGR system comprising a heat exchanger according to claim 1.
